(19) United States
(12) Patent Application Publication
(10) Pub. No.: US 2011/0191021 A1
(43) Pub. Date: Aug. 4, 2011

(54) APPARATUS AND METHOD FOR PROVIDING NAVIGATION FUNCTION IN PORTABLE TERMINAL

(75) Inventors: Dae-Yeon Jeong, Hwaseong-si (KR); Hyun-Suk Min, Suwon-si (KR)

(73) Assignee: SAMSUNG ELECTRONICS CO., LTD., Suwon-si (KR)

(21) Appl. No.: 13/018,646

(22) Filed: Feb. 1, 2011

(30) Foreign Application Priority Data
Feb. 1, 2010 (KR) 10-2010-0008959

(51) Int. Cl. G01C 21/00

(52) U.S. Cl. 701/201

(57) ABSTRACT

An apparatus and a method provide a navigation function in a portable terminal that is located indoors. The apparatus and method improves indoor path deviation determination by using space information in a portable terminal. The apparatus includes a path determiner that determines a travel path of a user and a path deviation of the user based on information related to a space where the user is located.

CROSS-REFERENCE TO RELATED APPLICATION(S) AND CLAIM OF PRIORITY

The present application is related to and claims the benefit under 35 U.S.C. §119(a) to an application filed in the Korean Intellectual Property Office on Feb. 1, 2010, and assigned Serial No. 10-2010-0008959, the entire disclosure of which is hereby incorporated by reference.

### TECHNICAL FIELD OF THE INVENTION

The present invention relates generally to an apparatus and a method for providing a navigation function in a portable terminal. More particularly, the present invention relates to an apparatus and a method for improving path deviation determination of a user who is moving indoors by using space information in a portable terminal.

### BACKGROUND OF THE INVENTION

With rapid growth of portable terminals, the portable terminal is one of the necessities for wireless voice communication and information exchange. Initially, the portable terminal featured its portability and wireless communication. As the portable terminal technology advances and wireless Internet is introduced, the portable terminal is expanding its application range from the simple telephone call to games, satellite broadcast viewing, remote controller using a short-range communication, image capturing using an embedded digital camera, and schedule management to satisfy the user's demands.

Such a portable terminal provides a navigation function which receives a satellite signal and provides information of a specific route to the user. The navigation function obtains a search path based on information of a departure point and a destination specified by the user and outputs a travel route on the road. The navigation function provides the travel path to the user based on the road of the user, determines whether the user strays from the path, and provides a new path to the destination.

Currently, according to the execution environment of the navigation function, a navigation function for a bicycle and an indoor navigation function for providing the path in a building are under development.

Similar to the automotive navigation function, when such navigation functions offer the travel path based on the preset path of the user, they cannot provide the accurate travel path and determine whether the user gets out of the path.

For instance, assuming that the user is in a wide space and looking for the exit, the user will freely walk in the wide space, rather than following the path to the exit. In this situation, the portable terminal which provides the travel path based on the preset path determines that the user frequently strays from the path, and thus searches for the path again.

To address this shortcoming, what is needed is an apparatus and a method for using the user's spatial travel path as the information to determine whether the user strays from the path, according to the execution environment of the navigation function of the portable terminal.

### SUMMARY OF THE INVENTION

To address the above-discussed deficiencies of the prior art, one aspect of the present invention to provide an apparatus and a method for providing an indoor travel path in a portable terminal.

Another aspect of the present invention is to provide an apparatus and a method for improving path deviation determination on an indoor movement in a portable terminal.

Yet another aspect of the present invention is to provide an apparatus and a method for improving path deviation determination using space information in a portable terminal.

In accordance with an aspect of the present invention, an apparatus for providing a navigation function in a portable terminal is provided. The apparatus includes a path determiner for determining a travel path of a user and a path deviation of the user based on information related to a space where the user is located.

In accordance with another aspect of the present invention, a method for providing a navigation function in a portable terminal is provided. The method includes determining a travel path of a user. The travel path includes a set of spaces. And a path deviation of the user is determined based on information related to a space where the user is located.

In accordance with another aspect of the present invention, an apparatus for providing a navigation function in a portable terminal is provided. The apparatus includes a communication unit for receiving search path information for an indoor navigation function. A display unit outputs a travel path according to the navigation function. An input put inputs data for a destination of the travel path. A memory unit stores map data for the indoor navigation function. A space determiner determines spaces belonging to a travel path to the destination of the user and determines a space where the user is located. A path determiner determines the travel path of the user and a path deviation of the user based on information related to the space where the user is located. And a controller processes and provides path information for the user who moves indoors using the space information.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal which provides an indoor navigation function according to an embodiment of the present invention;

FIG. 2 illustrates a process for providing the indoor navigation function in the portable terminal according to an embodiment of the present invention;

FIG. 3 illustrates a process for providing the indoor navigation function in the portable terminal according to an embodiment of the present invention;

FIG. 4 illustrates a process for determining path deviation using a space where the user moves in the portable terminal according to an embodiment of the present invention;

FIG. 5 illustrates a process for determining the path deviation using the space where the user moves in the portable terminal according to an embodiment of the present invention; and

FIG. 6 illustrates a process for determining the path deviation using the space where the user moves in the portable terminal according to an embodiment of the present invention.

Throughout the drawings, like reference numerals will be understood to refer to like parts, components and structures.

### DETAILED DESCRIPTION OF THE INVENTION

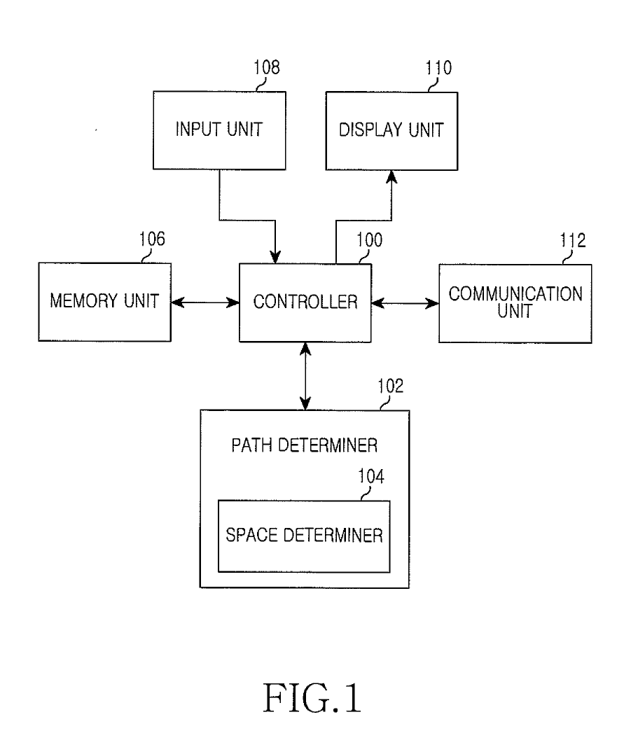

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal.

Embodiments of the present invention provide an apparatus and a method for providing an indoor navigation function by improving path deviation determination of a user who moves indoors using space information in a portable terminal.

FIG. 1 illustrates a portable terminal which provides an indoor navigation function according to an embodiment of the present invention.

As shown in FIG. 1 a portable terminal includes a controller 100, a path determiner 102, a memory unit 106, an input unit 108, a display unit 110, and a communication unit 112. The path determiner can further include a space determiner 104. The portable terminal may include additional units. Similarly, the functionality of two or more of the above units may be integrated into a single component.

The controller 100 of the portable terminal controls operations of the portable terminal. For example, the controller 100 processes and controls voice communication and data communication. In addition to controlling operations of the portable terminal, the controller 100 controls processes to provide the indoor navigation function which enhances the path deviation determination of the user who is moving indoors, using space information.

More specifically, using the space information as information for determining whether the user strays from the path, the controller 100 can provide the accurate path information with respect to the indoor movement with the user's wide movement. The controller 100 can determine whether the user deviates from the path more accurately than an automotive navigation function which determines the path deviation based on the lane.

Under the control of the controller 100, the path determiner 102 provides navigation information based on information of the space the user passed through. That is, the path determiner 102 determines whether the user strays from the searched path by comparing the user's travel space with the space information associated with the path to the searched destination.

Under the control of the path determiner 102, the space determiner 104 of the path determiner 104 determines the space belonging to the path leading to the destination of the user, provides the space to the path determiner 102, and determines the space of the user in the determined path such that the path determiner 102 can locate the user.

The memory unit 106 includes a ROM, a RAM, a flash ROM, and such. The ROM stores microcodes and reference data of a program for processing and controlling the controller 100 and the path determiner 102.

The RAM, which is a working memory of the controller 100, stores temporary data generated during the program execution. The flash ROM contains refreshable data such as phonebook, outgoing messages, and incoming messages. In an embodiment of the present invention, the flash ROM contains map data for the indoor navigation function.

The input unit 108 includes a plurality of function keys such as number key buttons 0˜9, menu button, cancel button, OK button, call button, end button, Internet access button, navigation key buttons, character input keys, and so forth. The input unit 108 provides the controller 100 with key input data corresponding to the key pressed by the user. In an embodiment of the present invention, the input unit 108 provides the controller 100 with the key input data of the interval (the destination) of the travel path to be serviced to the user.

The display unit 110 displays status information, characters, videos, and still images during the operations of the portable terminal. In an embodiment of the present invention, the display unit 110 displays the navigation information. The display unit 110 can employ a color Liquid Crystal Display device (LCD), an Active Mode Organic Light Emitting Diode (AMOLED), and such. When the display unit 110 includes a touch input device and is applied to a touch-type portable terminal, it can be used as the input device.

The communication unit 112 processes to transmit and receive radio signals of data input and output via an antenna (not illustrated). For instance, in the transmission, the communication unit 112 channel-encodes, spreads, Radio Frequency (RF)-processes, and transmits data. In the reception, the communication unit 112 converts the received RF signal to a baseband signal and restores the data by de-spreading and channel-decoding the baseband signal. Additionally, the communication unit 112 receives search path information for the indoor navigation function.

While the controller 100 of the portable terminal can serve as the path determiner 102, they are separately illustrated here to distinguish the respective functions, not to limit the scope of the invention. One skilled in the art shall understand various modifications can be made without departing from the spirit and scope of the invention. For example, the controller 100 can process all of the functions of the path determiner 102.

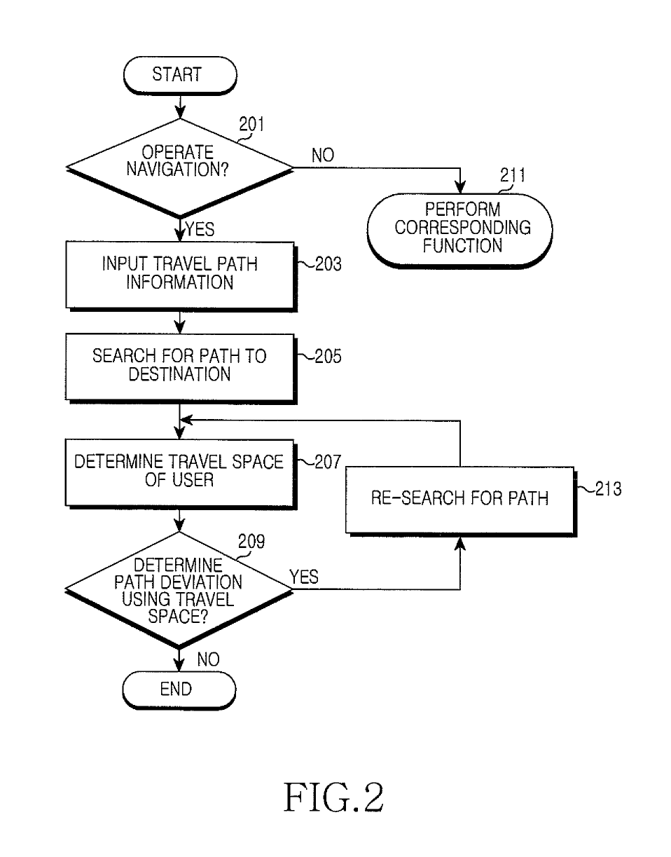

FIG. 2 illustrates a process for providing the indoor navigation function in the portable terminal according to an embodiment of the present invention.

As shown in FIG. 2, the indoor navigation function provides the search information which is the path to the user's intended destination indoors. By offering the search path based on the space where the user is moving, the indoor navigation function can provide the user with the more accurate search path than the automotive navigation function which determines the deviation based on the lane.

The portable terminal for providing the indoor navigation function operates the navigation in step 201 and determines whether to receive the search path information.

When the navigation does not operate in step 201, the portable terminal performs the corresponding function (e.g., a standby mode) in step 211.

When the navigation operates in step 201, the portable terminal receives the travel path information in step 203. Herein, in step 203, the endpoints of the travel path for the user of the portable terminal, that is, the information relating to the departure point and the destination is input. When the user of the portable terminal does not input the information of the endpoints of the travel path, the portable terminal can provide the search path information with respect to the user's travel direction based on the region where the user of the portable terminal is located. When providing the search path information with respect to the user's travel direction, the portable terminal can use current location information of the user as the travel path information.

The portable terminal receiving the travel path information searches for the path to the destination in step 205 and determines the travel space (e.g., room, office, and bathroom) of the user in step 207.

In step 209, the portable terminal determines whether the user moves along or strays from the travel path searched in step 205. Herein, the portable terminal determines the path deviation using the space where the user moves.

Unlike the automotive movement on the road, the indoor movement has many movements of the user. When the path deviation is determined through the simple linear travel path such as lane, the frequent determination of the path deviation can be addressed.

Upon determining that the user is straying from the searched path using the travel space in step 209, the portable terminal re-searches for the path to the destination in step 213 and repeats step 207.

Alternatively, upon determining the user not straying from the searched path using the travel space in step 209, the portable terminal provides the pre-searched travel path and then finishes this process.

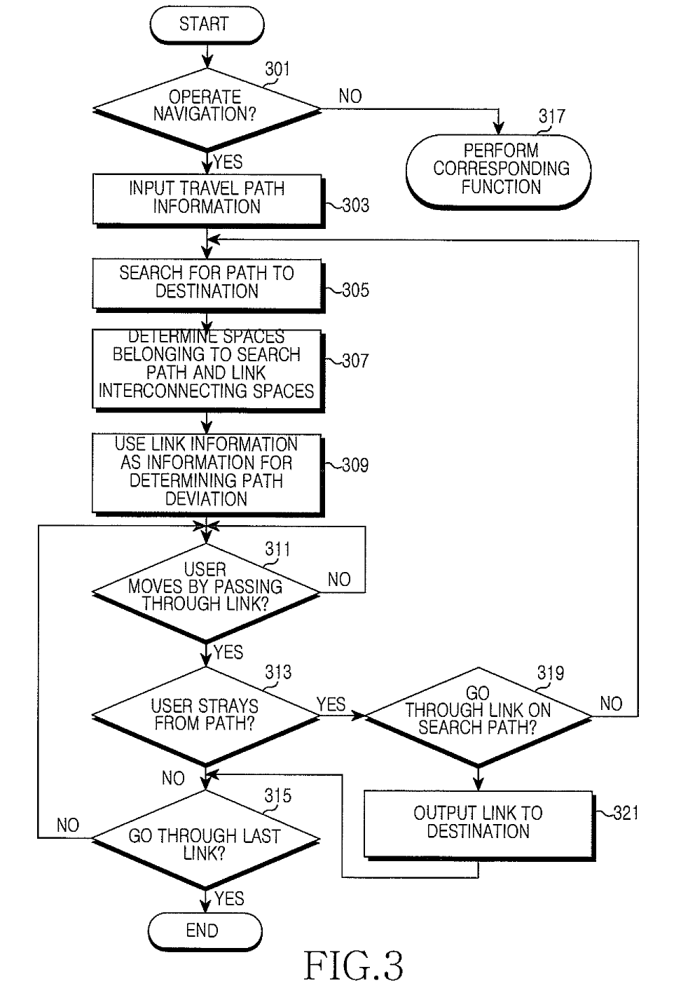

FIG. 3 illustrates a process for providing the indoor navigation function in the portable terminal according to an embodiment of the present invention.

As shown in FIG. 3, the portable terminal operates the navigation in step 301 and determines whether to receive the search path information.

When the navigation does not operate in step 301, the portable terminal performs the corresponding function (e.g., the standby mode) in step 317.

When the navigation operates in step 301, the portable terminal receives the travel path information in step 303 and then searches for the travel path to the destination in step 305.

In step 307, the portable terminal determines spaces included to the search path and links interconnecting the spaces. Herein, the space indicates the space (the space enclosed by the wall) to which the user of the portable terminal can move. The space may be the destination. The link, which indicates the basis for determining whether the user strays from the path, is the entrance point (e.g., the door) to the space.

In step 309, the portable terminal uses the information of the determined link as the information for determining the user's path deviation. That is, the portable terminal can determine the link the user is passing by and determine whether the user is moving along or strays from the searched path.

In step 311, the portable terminal observes the user's movement and determines whether the user passes through the link.

When the user does not pass through the link in step 311, the portable terminal repeats the step 311.

When the user moves by passing through the link in step 311, the portable terminal determines whether the user strays from the searched path by determining which link the user moves along in step 313.

When the user does not stray from the searched path in step 313, the portable terminal provides the user's searched path and then determines whether the user of the portable terminal goes through the last link of the searched path in step 315. Herein, passing through the last link of the searched path signifies that the user of the portable terminal arrives at the destination.

Upon determining that the user does not go through the last link in step 315, the portable terminal repeats the step 311.

Upon determining that the user goes through the last link in step 315, the portable terminal ends this process.

In contrast, upon determining that the user strays from the searched path in step 313, the portable terminal examines whether the link the user passes through out of the path belongs to the pre-searched path (e.g., going back to one of the passed links) in step 319.

When the user goes through the link belonging to the pre-searched path in step 319, the portable terminal outputs the link leading to the destination based on the pre-searched path in step 321.

Alternatively, when the user goes through the link not belonging to the pre-searched path in step 319, the portable terminal goes to step 305 to search for the path to the destination.

As such, by using the space that the user is moving into or the link for entering the space as the information for determining the path deviation, the accurate indoor travel path information with the wide movement can be provided.

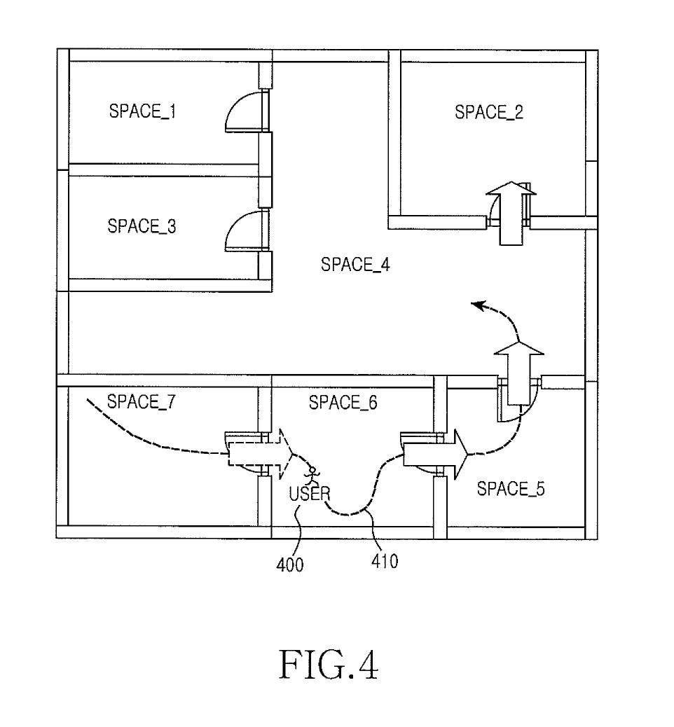

FIG. 4 illustrates a process for determining the path deviation when the user strays from the path by using the space where the user moves in the portable terminal according to an embodiment of the present invention.

As shown in FIG. 4, the portable terminal is indoors, and the path information through the indoor movement to the destination is provided.

It is assumed that the user 400 of the portable terminal enters the path information to move from the room #7 to the room #2.

The portable terminal searches for the travel path of the user 400 and outputs the spaces and the links. The portable terminal can output the path 410 of the user using the arrows as shown in FIG. 4.

When the user of the portable terminal starts to move, the portable terminal determines whether the user deviates from the path by determining the link that the user passes through.

When the user moves without straying from the searched path, the portable terminal makes the region passed by the user (i.e., the link passed by the user) disappear such that the user can re-confirm the path to proceed as shown in FIG. 4.

The portable terminal can determine whether the user deviates from the path by using the link interconnecting the spaces as the information for determining the path deviation.

Unlike the automotive movement on the road, the indoor travel involves many movements by the user. When the path deviation is determined through the simple travel path such as lane, the frequent determination of the path deviation can be addressed.

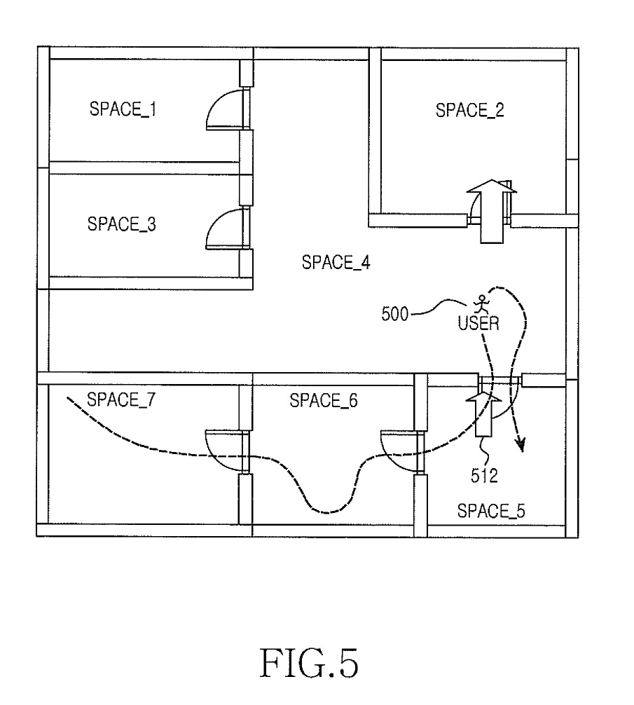

FIG. 5 illustrates a process for determining the path deviation using the space where the user moves in the portable terminal according to an embodiment of the present invention.

It is assumed that the portable terminal is placed indoors, as shown in FIG. 4, and travels by receiving from the user the path information to move from room #7 to room #2.

The portable terminal searches for the travel path of the user and outputs the spaces and the links. The portable terminal can output the path of the user by displaying the arrow as shown in FIG. 5.

If the user of the portable terminal moves from room #5 to room #4 in step 500 and then returns to room #5 instead of entering the destination room #2, the portable terminal determines that the user deviates from the path.

When the user migrates to room #5 as shown in FIG. 5, the general navigation system cannot determine the normal path deviation but determines the frequent path deviation. This is because the general navigation system provides the path information based on the fixed lane.

In contrast, the portable terminal according to an embodiment of the present invention determines whether the user gets out of the path using the space the user moves in or the link interconnecting the spaces, and thus provides the accurate the search path.

More specifically, the portable terminal can locate the user in room #4 by determining the link passed by the user to move from room #5 to room #4 as shown in FIG. 5. Upon determining that the user of the portable terminal goes through the link to move from room #4 to room #5, the portable terminal determines that the user goes backwards in the searched path.

The portable terminal determining the path deviation mostly re-searches for the path to the destination. When the link of the path deviation belongs to the pre-searched path, the portable terminal according to an embodiment of the present invention provides the search path of the destination using the existing path, rather than searching for a new path.

Hence, the portable terminal informs of the path to the destination by representing the arrow 512 in the link from room #5 to room #4 as shown in FIG. 5.

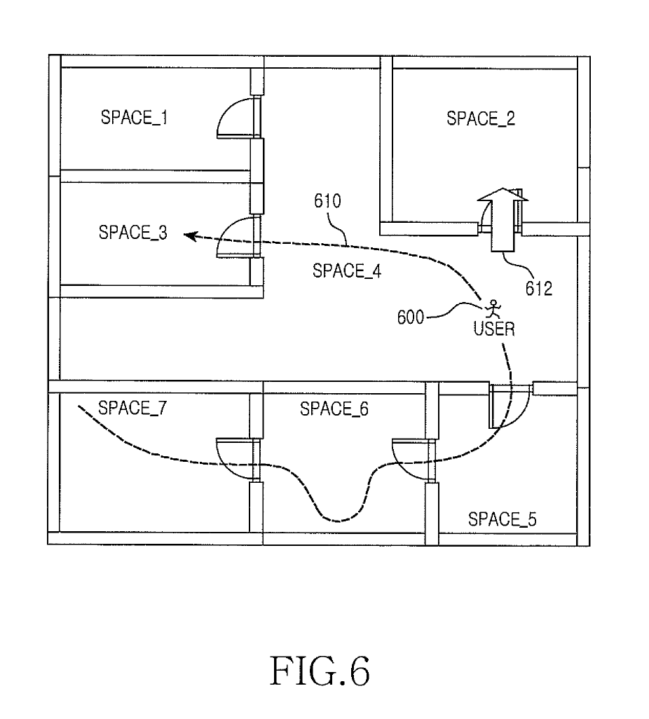

FIG. 6 illustrates a process for determining the path deviation using the space where the user moves in the portable terminal according to an embodiment of the present invention.

It is assumed that the portable terminal is placed indoors according to FIG. 4 and travels by receiving from the user the path information to move from room #7 to room #2.

The portable terminal searches for the travel path for the user and outputs the spaces and the links. The portable terminal can output the path of the user by displaying the arrow as shown in FIG. 6.

If the user of the portable terminal moves from room #5 to room #4 in step 600 and then enters room #3 rather than entering the destination room #2, the portable terminal determines that the user strays from the path.

The portable terminal can locate the user in room #4 by determining the link passed by its user to move from room #5 to room #4 as shown in FIG. 6. Upon determining the travel direction of the user of the portable terminal (i.e., by determining the link passed by the portable terminal to enter room #3) the portable terminal can determine that the user has deviated from the search path.

Accordingly, the portable terminal re-searches for the path and informs of the path to the destination by displaying the arrow 612 in the link connecting to the room #2 such that the user can move to the destination.

Unlike FIG. 5, because the link that the user passes through does not belong to the pre-searched path, the portable terminal searches for the new path.

As set forth above, the apparatus and the method in the portable terminal provides the indoor navigation function by improving the path deviation determination on the indoor movement using the space information. Therefore, by using the space information of the user, rather than the lane, as the information to determine whether the user strays from the path, it is possible to address the frequent path deviation determination of the conventional portable terminal with respect to the user who is moving indoors.

Although the present disclosure has been described with an embodiment, various changes and modifications may be suggested to one skilled in the art. It is intended that the present disclosure encompass such changes and modifications as fall within the scope of the appended claims.

What is claimed is:

1. An apparatus for providing a navigation function in a portable terminal, the apparatus comprising:
a path determiner configured to determine a travel path of a user and a path deviation of the user based on information related to a space where the user is located.

2. The apparatus of claim 1, wherein the path determiner searches for the travel path to a destination, compares a next space along the travel path with the space where the user is located, determines that the user has not deviated from the travel path when determining that the space where the user is located coincides with the next space along the travel path, and determines that the user has deviated from the travel path when determining that the space where the user is located does not coincide to the next space along the travel path.

3. The apparatus of claim 2, wherein, after determining that the user has deviated from the travel path:
when determining that the space where the user is located coincides with a previous space along the travel path, the path determiner guides the path to the destination using a space along the travel path that follows the previous space along the travel path, and
when determining that the space where the user is located does not coincide with any space along the travel path, the path determiner re-searches for a new travel path to the destination.

4. The apparatus of claim 2, wherein, when determining that the space where the user is located coincides with the next space along the travel path, the path determiner determines that the user does not deviate from the travel path so as to determine the path deviation without regard to wide movements within the space.

5. The apparatus of claim 2, wherein the path determiner divides the travel path to the destination into spaces and removes the space passed by the user from an output screen.

6. The apparatus of claim 1, wherein the information related to the space where the user moves comprises at least one of a space enclosed by walls in a building, a region subdivided from the space, and a link for entering the space.

7. The apparatus of claim 1, wherein the path determiner detects a movement when the user passes through a link between spaces.

8. A method for providing a navigation function in a portable terminal, the method comprising:
determining a travel path of a user, the travel path comprising a set of spaces; and
determining a path deviation of the user using information related to a space where the user is located.

9. The method of claim 8, wherein determining the path deviation comprises:
determining a next space along the travel path;
comparing the next space along the travel path with the space where the user is located;
when determining that the space where the user is located coincides with the next space along the travel path, determining that the user has not deviated from the travel path; and
when determining that space where the user is located does not coincide with the next space along the travel path, determining that the user has deviated from the travel path.

10. The method of claim 9, further comprising:
after determining that the user gets out of the path:
determining a space the user enters after deviating from the path,
determining whether the determined space coincides with a previous space along the travel path,
in response to determining that the determined space coincides with a previous space along the travel path, guiding the path to the destination using a space along the travel path that follows the previous space along the travel path, and
when determining that the determined space does not coincide with any space along the travel path, re-searching for a new travel path to the destination.

11. The method of claim 9, wherein determining whether the space where the user is located coincides with the next space along the travel path determines the path deviation without regard to wide movements within the space.

12. The method of claim 9, further comprising:
dividing the travel path to the destination into spaces; and
making the space passed by the user disappear in an output screen.

13. The method of claim 8, wherein the information related to the space where the user moves comprises at least one of a space enclosed by walls in a building, a region subdivided from the space, and a link for entering the space.

14. The method of claim 8, wherein determining a path deviation of the user comprises detecting a movement when the user passes through a link between spaces.

15. An apparatus for providing a navigation function in a portable terminal, the apparatus comprising:
a communication unit configured to receive search path information for an indoor navigation function;
a display unit configured to output a travel path according to the navigation function;
an input unit configured to input data for a destination of the travel path;
a memory unit configured to store map data for the indoor navigation function;
a space determiner configured to determine spaces belonging to a travel path to the destination of the user and determine a space where the user is located;
a path determiner configured to determine the travel path of the user and a path deviation of the user based on information related to the space where the user is located; and
a controller configured to process and provide path information for the user who moves indoors using the space information.

16. The apparatus of claim 15, wherein the path determiner determines whether the user deviates from the travel path by comparing a next space along the travel path determined by the space determiner with the space where the user is located.

17. The apparatus of claim 16, wherein, the path determiner, after determining that the user has deviated from the travel path, determines whether the space where the user is located coincides with a previous space along the travel path,
wherein, when determining that the space where the user is located coincides with a previous space along the travel path, the path determiner guides the path to the destination using a space along the travel path that follows the previous space along the travel path, and
when determining that the space where the user is located does not coincide with any space along the travel path, the path determiner re-searches for a new travel path to the destination.

18. The apparatus of claim 15, wherein the controller divides the path to the destination of the user into spaces and removes the space passed by the user disappear from an output screen.

19. The apparatus of claim 15, wherein the information related to the space where the user moves comprises at least one of a space enclosed by walls in a building, a region subdivided from the space, and a link for entering the space.

20. The apparatus of claim 15, wherein the controller detects a movement when the user passes through a link between spaces.
